(19) United States
(12) Patent Application Publication
(10) Pub. No.: US 2009/0012975 A1
(43) Pub. Date: Jan. 8, 2009

(54) PORTABLE ELECTRONIC DEVICE AND FILE MANAGEMENT METHOD FOR USE IN PORTABLE ELECTRONIC DEVICE

(75) Inventor: Hajime Takeda, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/166,606

(22) Filed: Jul. 2, 2008

(30) Foreign Application Priority Data
Jul. 3, 2007 (JP) 2007-175565
Jun. 30, 2008 (JP) 2008-170228

(51) Int. Cl. G06F 17/30

(52) U.S. Cl. 707/100; 707/200; 707/E17.005

(57) ABSTRACT

A first decision is made as to whether or not to make access to a first file defined by a first file management information, of the plurality of items of file management information having the same file identification information, which has file use order information indicating that the first file is first in the order of use. If the decision is that the first file is not to be accessed, a second decision is made as to whether or not to make access to a second file defined by a second file management information, of the items of file management information having the same file identification information, which has use order information indicating the second file is second in the order of use.

### CROSS-REFERENCE TO RELATED APPLICATIONS

This application is based upon and claims the benefit of priority from prior Japanese Patent Applications No. 2007-175565, filed Jul. 3, 2007; and No. 2008-170228, filed Jun. 30, 2008, the entire contents of both of which are incorporated herein by reference.

### BACKGROUND OF THE INVENTION

1. Field of the Invention

The present invention relates to a portable electronic device, such as an IC card, which makes access to a file in a nonvolatile memory in response to a command from an external device and a file management method for use in such a portable electronic device.

2. Description of the Related Art

Conventionally, a portable electronic device, such as an IC card (smart card), has a rewritable nonvolatile memory which stores data and a control device which carries out processing on data in the nonvolatile memory. With such a portable electronic device, data to be stored in the nonvolatile memory are usually managed by file (see, for example, Japanese Patent No. 2695857). Such an IC card as manages data by file is not adapted to make direct access to data stored in the nonvolatile memory. That is, the IC card first makes access to a file stored with desired data and then reads data from or writes data into that file.

The IC card is adapted to operate in response to a command which is a processing instruction from the external device. For example, the IC card responds to a command from the external device to carry out a process of making access to data stored in a file. The command issued to the IC card is defined by prescribed standards. That is, the external device makes a request to the IC card for access to desired data with a command defined by the prescribed standards. Then, the IC card interprets the command on the basis of the prescribed standards and performs processing corresponding to the command.

As described above, the IC card is adapted to operate on the basis of prescribed standards. For example, ISO/IEC7816-4, which is the international standards of IC cards, defines the structure and form of a file to store data (data file referred to as an elementary file (EF)). In ISO/IEC7816-4, commands to make access to each file in the IC card are also defined.

In ISO/IEC7816-4, a structure that has a number of records to store data in a data file (record structure) is defined as the structure of data in data files in the IC card. In ISO/IEC7816-4, commands to make a request for access to a file of such a record structure are also defined. However, ISO/IEC7816-4 places a limit on the number of records that can be stored in one data file. For this reason, with ISO/IEC7816-4, commands to make a request for access to a file of the record structure are subject to a limitation on the number of records which can be specified as candidates for access.

ISO/IEC7816-4 supposes 254 as the maximum number of records that can be stored in a single file. That is, ISO/IEC7816-4 supposes that up to 254 records, which are numbered 1 to 254, are stored in one file. For this reason, in a command to make a request for access to a record in ISO/IEC7816-4, the number of a record that can be specified as a candidate for access is given by “01” to “FE” in hexadecimal (i.e., 1 to 254 in decimal).

In recent years, IC cards or similar portable electronic devices have come to have various uses. For example, one form of use which is expected is such that a brochure which has an IC chip adapted to operate according to international standards, such as ISO/IEC7816-4, embedded is used as a passport by way of example. As portable electronic devices are used in various forms, it is expected that the demand will increase for recording more records than defined by the standards in one file. For example, suppose a method of use in which information concerning entry (entry into a country), exit (departure from the country), and the like is written into a passport having an IC chip embedded without erasing old information. In such a case, there will occur a situation that it is required to record more records than specified by the standards in one file. Also, with an IC card used in a system to manage entry into and exit from a security area or a system for business transactions involving settling accounts, it is also expected that a request may occur to record a large amount of history information concerning entry and exit or transactions.

With such existing standards as described above, however, each data file cannot contain more records than defined in advance. That is, in a system which conforms to the existing standards, one data file can handle only as many records as defined in advance. Considering that IC cards will be used in various fields in future, it is desirable to make it possible to expand the maximum number of records that can be stored in a data file of record structure. Furthermore, considering operating conditions of existing systems, it is desired that, even when the maximum number of records is expanded, existing commands defined in ISO/IEC7816-4 be capable of making access to each record in a data file.

### BRIEF SUMMARY OF THE INVENTION

The object of the present invention is to provide a portable electronic device which is capable of readily expanding the amount of data that can be managed in a specific file, a file management method for use in such a portable electronic device, and an IC card.

According to an aspect of the invention, there is provided a portable electronic device comprising: a first memory to store data by file; a second memory to store a plurality of items of file management information having the same file identification information for files and different file use order information indicating the order of use of the files; a first access decision section which, upon receiving a command from an external device, makes a decision of whether or not to make access to a first file defined by that file management information, of the plurality of items of file management information having the same file identification information, which has file use order information indicating that the first file is first in the order of use; a second access decision section which, if the decision by the first decision section is that the first file is not to be accessed, makes a decision of whether or not to make access to a second file defined by that file management information, of the items of file management information having the same file identification information, which has use order information indicating the second file is second in the order of use; and a processing section which carries out processing corresponding to the command on the file decided by the first or second decision section to be accessed.

According to another aspect of the invention, there is provided a file management method for use with a portable electronic device comprising: storing data in a first memory on a file basis; storing in a second memory a plurality of items of file management information having the same file identification information for files and different file use order information indicating the order of use of the files; upon receiving a command from an external device, making a first decision of whether or not to make access to a first file defined by that file management information, of the plurality of items of file management information having the same file identification information, which has file use order information indicating that the first file is first in the order of use; if the decision is that the first file is not to be accessed, making a second decision of whether or not to make access to a second file defined by that file management information, of the items of file management information having the same file identification information, which has use order information indicating the second file is second in the order of use; and carrying out processing corresponding to the command on the file decided by the first or second decision to be accessed.

According to still another aspect of the invention, there is provided an IC card comprising: a module; and a body in which the module is embedded, the module comprising a first memory to store data by file, a second memory to store a plurality of items of file management information having the same file identification information for files and different file use order information indicating the order of use of the files, a first access decision section which, upon receiving a command from an external device, makes a decision of whether or not to make access to a first file defined by that file management information, of the plurality of items of file management information having the same file identification information, which has file use order information indicating that the first file is first in the order of use, a second access decision section which, if the decision by the first decision section is that the first file is not to be accessed, makes a decision of whether or not to make access to a second file defined by that file management information, of the items of file management information having the same file identification information, which has use order information indicating the second file is second in the order of use, and a processing section which carries out processing corresponding to the command on the file decided by the first or second decision section to be accessed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram of an IC card as a portable electronic device;

FIG. 2 is a diagram for use in explanation of a contact IC card;

FIG. 3 is a diagram for use in explanation of a non-contact IC card;

FIG. 4 schematically shows a file organization in a data memory;

FIGS. 5A and 5B schematically show a data structure in a file;

FIG. 6 schematically shows file management information;

FIG. 7 is a flowchart illustrating the flow of processing for the APPEND RECORD command; and

FIG. 8 is a flowchart illustrating the flow of processing for the READ RECORD command.

### DETAILED DESCRIPTION OF THE INVENTION

An embodiment of the present invention will be described hereinafter with reference to the accompanying drawings.

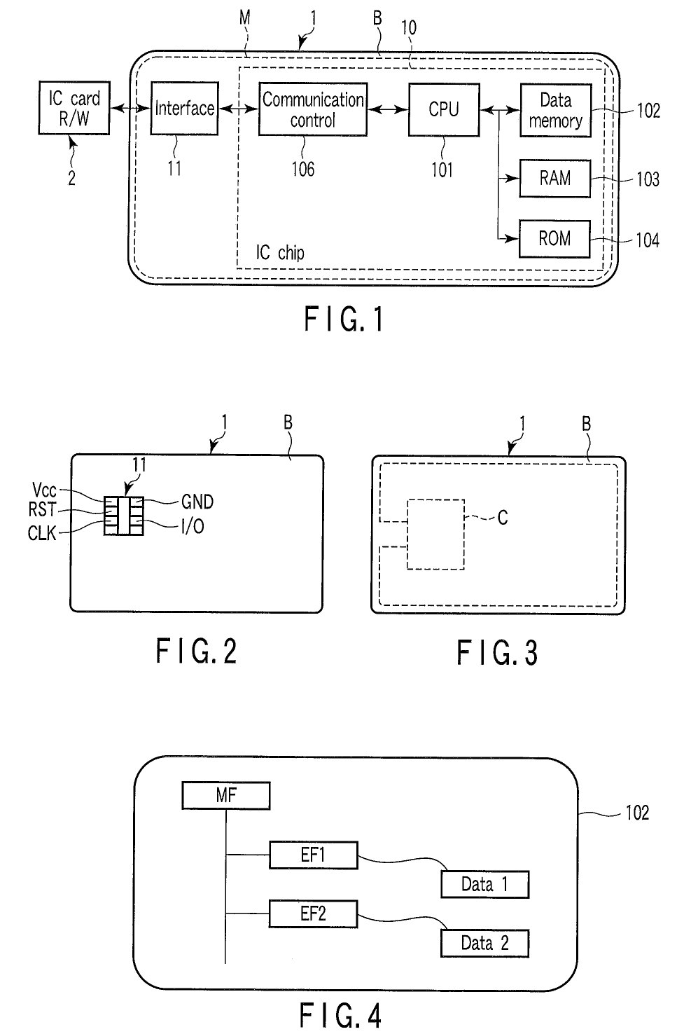

FIG. 1 is a block diagram of an IC card 1 as a portable electronic device according to an embodiment of the present invention and an IC card system including the IC card.

The IC card 1 is placed in the operable state when powered from an IC card reader/writer 2 as an external device. The IC card 1 which has been placed in the operable state performs various processes in response to commands from the IC card reader/writer 2. The IC card reader/writer 2 supplies power to the IC card 1 and issues commands to it to request various processes.

The IC card 1 may be either a contact IC card (contact portable electronic device) or a contactless IC card (contactless portable electronic device). The contact IC card is adapted to make communication with the IC card reader/writer 2 when brought into physical contact with it. The contactless IC card makes communication with the IC card reader/writer in the state where they are not in contact with each other through the use of an antenna and a wireless communication unit. Furthermore, the IC card 1 may be a composite IC card (dual interface IC card) which has communication facilities as a contact IC card and communication facilities as a contactless IC card. The contact IC card and the contactless IC card differ from each other only in the method of communication with an external device. For this reason, examples of processing to be described later are applicable to both types of IC cards.

Next, the configuration of the IC card 1 will be described.

As shown in FIG. 1, the IC card 1 is formed such that a module M is embedded in a card-shaped body B. The module M is integrally formed from at least one IC chip 10 and an interface 11 which are connected with each other. The IC chip 10 is composed of a CPU (central processing unit) 101, a data memory, a RAM 103, a ROM 104, a communication control unit 106 and a power supply (not shown). The communication control unit 106 of the IC chip 10 is connected with the interface 11.

The CPU 101 controls the whole of the IC card 1. The CPU 101 operates on the basis of a control program and control data stored in the ROM 104 or the data memory 102. By executing the control program, the CPU 101 functions as a processor to perform various processes.

The data memory 102 consists of a rewritable (erasable) nonvolatile memory, such as an EEPEOM (electrically erasable and programmable read only memory) or a flash ROM. The data memory 102 is stored with various pieces of information to suit the purpose of use of the IC card 1. For example, the data memory 102 is stored with application data for implementing various functions. The data memory 102 also stores various pieces of data in such a way that they are stored in files. The structure of files in the data memory 12 conforms to ISO/IEC7816-4, for example.

The RAM 103 is a volatile memory which can be accessed at high speed and functions as a buffer memory to temporarily store data. For example, the RAM 103 temporarily stores data which are received and sent during communication processing with the IC card reader/writer 2. The RAM 103 also functions as a working memory to temporarily hold data which are being processed by the CPU 101.

The ROM 104 is a nonrewritable nonvolatile memory. For example, the ROM consists of a read-only memory, such as a masked ROM. The ROM functions as a program memory stored with a control program executed by the CPU 101. In particular, the ROM 104 is stored with a control program to perform basic operations corresponding to the specifications of the IC card 1 and control data. For example, the ROM 104 is stored with a control program that allows the CPU 101 to carry out processes corresponding to externally applied commands.

The communication control unit 106 controls data communications with the IC card reader/writer 2 via the interface 11. For example, when the IC card 1 is a contact IC card, a contact type communication function is implemented by the interface 11 as a contact member and the communication control unit 106. When the IC card 1 is a contactless IC card, a non-contact type communication function is implemented by an antenna as the interface 11 and a modem (modulator/demodulator) as the communication control unit 106.

With the IC card 1 thus configured, when a command is given by the IC card reader/writer 2 to write data into the data memory 102, the CPU 101 executes the control program stored in the ROM 104 to carry out a process of writing data into the data memory. When the IC card reader/writer 2 issues a command to read data stored in the data memory 102, the CPU 101 executes the control program to carry out a process of reading data from the data memory. Furthermore, the IC card 1 is adapted to implement various processes corresponding to the uses of the IC card 1 by the CPU 101 executing processing programs installed according to the uses of the IC card.

FIG. 2 is an exterior view of a contact IC card as a form of the IC card 1. As shown in FIG. 2, the contact IC card is formed so that its contact member as the interface 11 is exposed on the surface of the body B. With the contact IC card, the module M having one or more IC chips C connected to the exposed contact member is built into the card-shaped body B. As shown in FIG. 2, the contact member as the interface 11 of the contact IC card is composed of a plurality of terminals: a supply voltage terminal Vcc, a ground terminal GND, a reset terminal RST, an input/output terminal I/O, and a clock terminal CLK.

FIG. 3 shows the configuration of a non-contact IC card as a form of the IC card 1. With the non-contact IC card, as shown in FIG. 3, a module M having one or more IC chips C and an antenna as the interface 11, which are shown by dotted lines, is embedded in the card-shaped body B. Thus, in the non-contact IC card, radio signals transmitted or received by the antenna are processed by the IC chip C.

Next, the organization of files stored in the data memory 102 will be described.

FIG. 4 schematically shows an example of file organization in the data memory 102.

As shown in FIG. 4, in the data memory 102, various files are managed in a hierarchical structure with master file (MF) set at the highest level. In the example of FIG. 4, two elementary files (EF) EF1 and EF2 are present at the level next to that of the master file MF. It is also possible to define a DF file at the level next to that of the master file MF and define elementary files at the level next to that of the DF file.

The elementary files EF1 and EF2 are ones to store real data. That is, in the data memory 102, real data are stored in such elementary files as shown in FIG. 4. In other words, real data are managed for each elementary file in the data memory 102. In order to make access to real data, therefore, it is required to select each elementary file.

Next, the structure of data in the elementary files (data files) will be described.

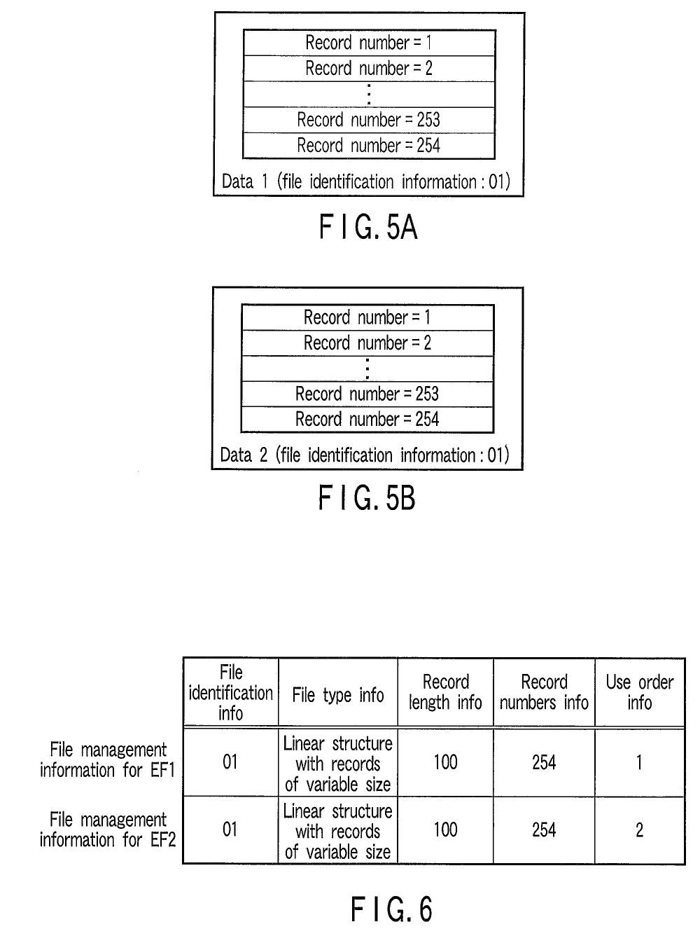

FIGS. 5A and 5B schematically show the structure of data in the data files. It is assumed here that FIG. 5A shows the structure of data 1 in the elementary file ER1 in FIG. 4 and FIG. 5B shows the structure of data 2 in the elementary file EF2. Such elementary files (data files) as shown in FIGS. 5A and 5B are stored in a data storage area set up in the data memory 102.

In the elementary files EF1 and EF2, real data are stored as 254 records having record numbers of 1 to 254. Here, the structure in which data are stored as records in a file is referred to as the record structure.

Here, ISO/IEC7816-4, which is the international standard for IC cards, specifies the following data structures in elementary files:

(F1) Transparent structure

(F2) Linear structure with records of fixed size: this is a structure such that records of fixed length are arranged in sequence in a data file. With this type of data file, records of fixed length are written in sequence.

(F3) Linear structure with records of variable size: this is a structure such that records of variable length are arranged in sequence in a data file. With this type of data file, records of variable length are written in sequence.

(F4) Cyclic structure with records of fixed size: this is a structure such that records of fixed length are arranged cyclically in a data file. With this type of data file, records of fixed length are cyclically written or rewritten.

(F5) TLV structure: each record in a data file is composed of tag, length, and value.

In (F1), the data structure is not the record structure but the transparent structure. In (F2) to (F5), the data structure is the record structure. That is, in ISO/IEC7816-4, such structures as in (F2) to (F5) are specified as elementary files (data files) of the record structure. With data files of such record structures as (F2) to (F5), real data are stored in each record. In ISO/IEC7816-4, however, the upper limiting value of the number of records that can be stored in each data file is specified to be 254 (the record numbers are 1 to 254). For this reason, it is impossible to store an additional record or records in a data file which has been stored with records numbered 1 to 254 like the elementary files EF1 and EF2 shown in FIG. 4 (no record to store real data cannot be set up).

Next, access to a data file of such record structures as described above will be described.

As described above, the IC card 1 is adapted to operate in response to commands from an external device. For this reason, control of access to data files can be described as processing for commands. Therefore, a description is given here of commands to request access to a data file of the record structure.

For instance, as commands to request access to data files of the record structure, ISO/IEC7816-4 specifies the following commands:

(C1) READ RECORD(S) Command

(C2) WRITE RECORD Command

(C3) APPEND RECORD Command

(C4) SEARCH RECORD Command

(C5) ERASE RECORD(S) Command

Of the commands of (C1) to (C5), each of the commands except the APPEND RECORD Command can specify the number of a record to be accessed. As described above, ISSSO/IEC7816-4 assumes that the upper limiting value of the number of records that can be stored in each data file is 254. For this reason, in ISO/IEC7816-4, the record number which can be specified by each command ranges from 91 to FE in hexadecimal (1 to 254 in decimal).

With the APPEND RECORD Command of (C3), on the other hand, a request can be made to make access to a record to be accessed without specifying its record number. The APPEND RECORD Command is frequently utilized as a command to make a request to sequentially record data of a particular type (for example, history information representing the contents of a series of processes). In general, it is expected that there can occur a situation such that a data file in which history information is sequentially recorded (i.e., a data file requested by the APPEND RECORD Command to sequentially record data) exceeds the upper limiting value of the number of records assumed by ISO/IEC7816-4. That is, it is expected that data management efficiency can be increased by increasing the upper limit value of the number of records in a data file in which data are sequentially recorded based on the APPEND RECORD Command.

With the IC card of this embodiment, the number of records that can be stored in a particular data file can be increased. It should be noted here that the particular data file is not necessarily one physical data file. The particular data file is supposed to include two or more data files that are recognized as one data file by an external device such as the IC card reader/writer 2. As will be described later, it is expected that two data files having the same file identification information will be recognized as one data file (a particular data file) by an external device.

The form of management of the elementary files will be described next.

FIG. 6 shows an exemplary format of definition information (management information) for managing the elementary files. In FIG. 6 is shown file management information for the elementary file EF1 shown in FIG. 5A and the elementary file EF2 shown in FIG. 5B. The file management information is stored in a management information storage area set up in the data memory 102.

As shown in FIG. 6, the file management information for each file is made up of file identification information (short EF identifier), file type information, record length information, maximum record numbers information, and use order information. The file identification information identifies a data file. Each data file is identified by the file identification information which specifies it. For this reason, two or more files having the same file identification information are recognized as one file by the external device.

The file type information contains information indicating the data structure of the corresponding file. For example, when the data structure of the corresponding file is the record structure, the file type information indicates one of the structures of (F2) to (F5). The record length information is information indicating the size of each record in the corresponding file. The maximum record numbers information is information indicating the maximum number of records that can be stored in the corresponding file. The use order information is set up when there are two or more files of the same file identification information and indicates the order in which they are used.

This embodiment assumes that the items of file management information for two or more files of the same file identification information are identical in all information except the use order information. In addition, this embodiment supposes that integers are set starting with 1 as the use order information for files of the same file identification information. For example, where there are two files of the same file identification information, the use order information for one file is set to 1 and the use order information for the other is set to 2.

In the example of FIG. 6, the file management information for the elementary file EF1 is set such that the file identification information is 01, the file type is the linear structure with records of fixed size, the record length is 100 bytes, the maximum number of records is 254, and the order of use is 1. Also, the file management information for the elementary file EF2 is such that the file identification information is 01, the file type is the linear structure with records of fixed size, the record length is 100 bytes, the maximum number of records is 254, and the order of use is 2.

As shown in FIG. 6, the elementary files EF1 and EF2 differ from each other only in the use order information. Such files, which are physically two files, are logically handled as one file. That is, in a state in which a file the file identification information of which is 01 is selected, the elementary files EF1 and EF2 are accessed in sequence according to the order set by the use order information.

Next, exemplary processing in such an IC card as described above will be described.

First, a description is given of the flow of processing associated with the APPEND RECORD Command (C3) as a first example of processing in the IC card 1.

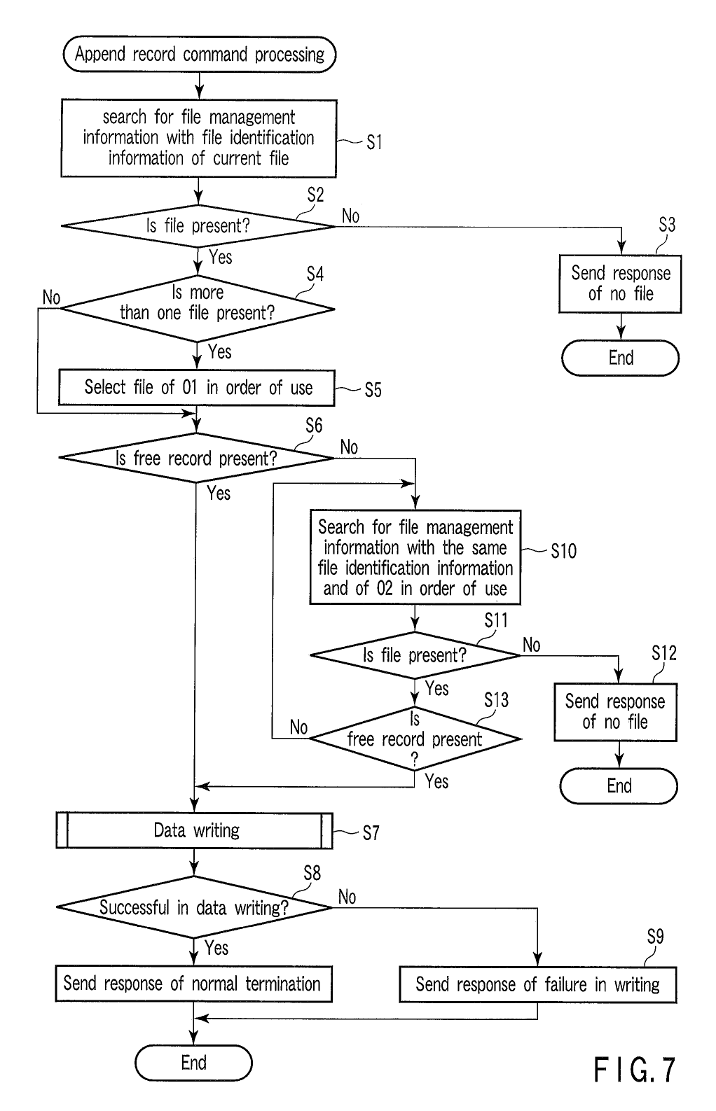

FIG. 7 is a flowchart illustrating the flow of processing associated with the APPEND RECORD Command (C3). In the description which follows, it is assumed that a file (current file) to be accessed with the APPEND RECORD Command (C3) is an elementary file having file identification information of 01 and the linear structure with records of variable size as shown in FIG. 6. In addition, it is assumed that data to be written with the APPEND RECORD Command has a size which can be stored as a record in a file the file identification information of which is 01. Furthermore, it is assumed that there is no need of security conditions for writing data with the APPEND RECORD Command.

The IC card 1 is activated when powered from the IC card reader/writer 2. In the activated state, the IC card 1 is capable of receiving a command from the IC card reader/writer 2. Upon receiving a command, the CPU 101 of the IC card 1 carries out a process of deciding that command. In this case, the CPU 101 decides that the received command is the APPEND RECORD Command. In such a case, the CPU 101 of the IC card 1 carries out such processing as shown in FIG. 7.

That is, upon receiving the APPEND RECORD Command, the CPU 101 searches two or more items of file management information stored in the data memory 102 for file management information having file identification information of the file (current file) which is now being selected (step S1). When this retrieval processing decides that there is no file management information having the file identification information of the current file (NO in step S2), the CPU 101 sends to the IC card reader/writer 2 a response which indicates an error of no file and causes the processing for the APPEND RECORD Command to result in error termination (step S3).

If the decision in the retrieval processing is that there is file management information having the file identification information of the current file (YES in step S2), then the CPU 101 makes a decision of whether or not there are two or more items of file management information having the same file identification information as that of the current file (step S4).

If the decision is that there are two or more items of file management information having the same file identification information as that of the current file (YES in step S4), then the CPU 101 selects as a candidate for access a file which corresponds to the file management information the use order information of which indicates the top in the order of use (step S5). If, on the other hand, there is only one item of file management information having the file identification information of the current file (NO in step S4), then the CPU 101 selects as a candidate for access the file corresponding to that file management information.

For example, if, when there are two or more items of file management information the file identification information of which is 01 as shown in FIG. 6, the file identification information of a file being selected is 01, the CPU 101 will select as a candidate for access a file in which the file identification information is 01 and the use order information is 01 through steps S1 to S5.

When file management information having the file identification information of the current file is one in number, only one file is present which can be selected as a candidate for access by the APPEND RECORD Command. In such a case, that file is simply processed as its order of use being 01 in the flow of processing shown in FIG. 7.

When a file to be accessed is selected as the result of the above processing, the CPU 101 makes a decision of whether or not a new record can be added to the selected file (step S6). In other words, the CPU 101 carries out in step S6 a process of making a decision of whether or not the selected file has a free record (free area) which can be written into.

For example, when the maximum number of records that can be stored in one file is 254, in step S6 the CPU 101 makes a decision of whether or not 254 records numbered 1 to 254 have already been written into the file the use order information of which is 01.

If the decision is that a new record can be written into the selected file (YES in step S6), the CPU 101 carries out a process of writing data specified by the received APPEND RECORD Command into the file as a new record (step S7). If additional data has been successfully written into the file (YES in step S8), then the CPU 101 sends a response indicating normal termination of the processing for the APPEND RECORD Command to the IC card reader/writer 2 and terminates the processing. If, on the other hand, the writing of additional data has resulted in failure (NO in step S8), then the CPU 101 sends a response indicating failure in data writing to the IC card reader/writer 2 and causes the processing for the APPEND RECORD Command to result in error termination (step S9).

If the decision is that an additional record cannot be written into the selected file (NO in step S6), then the CPU 101 searches for file management information of a file the file identification information of which is the same as that of the selected file and the order of use of which is next to the selected file (step S10).

For example, if, when there are two or more items of file management information in which the file identification information is 01 as shown in FIG. 6, the file identification information of the selected file is 01 and the use order information of the selected file is 01, the CPU 101 selects in step S10 as a candidate for access the file the file identification information of which is 01 and the use order information of which is 02.

If the decision is that there is no file which is next in the order of use (NO in step S11), then the CPU 101 sends a response indicating an error due to absence of free record to the IC card reader/writer 2 and makes the processing cause error termination (step S12). The process in step S12 is to notify the APPEND RECORD Command originator that additional writing of data (addition of a record) is impossible because the maximum number of records have already been stored in the selected file.

When a file which is next in the order of use is found by the search processing (YES in step S11), the CPU 101 selects that file which is next in the order of use as a candidate for access and, as in step S6, makes a decision of whether or not a new record can be added to the selected file (step S13).

If the decision is that a new record can be added to the selected file (YES in step S13), the CPU 101 writes additional data specified in the received APPEND RECORD Command into the file as a new record (step S7). If such additional data has been successfully written into the file (YES in step S8), the CPU 101 sends to the IC card reader/writer a response indicating normal termination of the processing for the APPEND RECORD Command and terminates the processing. If, on the other hand, the writing of additional data has failed (NO in step S8), the CPU 101 sends a response indicating failure in data writing to the IC card reader/writer 2 and causes the processing for the APPEND RECORD Command to result in error termination (step S9).

If the decision is that no additional record can be written into the selected file (NO in step S13), then the CPU 101 returns to step S10 to repeat the above processing. For example, if 254 records have also been stored in the file for which the use order information is 02, the CPU 101 returns to step S10 to search for file definition information in which the use order information is 03.

As described above, upon receiving the APPEND RECORD Command, the IC card retrieves file management information defining a file which is first in the order of use from all file management information having the file identification information of the current file. Upon detecting such file management information, the IC card makes a decision of whether or not a free record is present in the file defined by that file management information. If the decision is that no free record is present in that file, then the IC card searches again for file management information for a file which is second in the order of use. Upon detecting file management information for a file which is second in the order of use, the IC card makes a decision of whether or not a free record is present in the file defined by that file management information. If the decision is that a free record is present in that file, then the IC card writes data into the free record in the file which is second in the order of use.

That is, upon receiving the APPEND RECORD Command, the IC card writes data into a free record in the file which is second in the order of use when no free record is present in the file which is first in the order of use. Such processing allows the IC card to write more records than can be stored in one file as records that can be accessed by one item of file identification information. Two or more files having the same file identification information are recognized as one file by the external device which is the command originator. Therefore, when viewed from the external device, records can be written into the current file of the IC card in greater numbers than a predetermined maximum number of records that can be stored in one file.

Next, a description is given of the flow of processing associated with the READ RECORD Command (C1) as a second example of processing in the IC card 1.

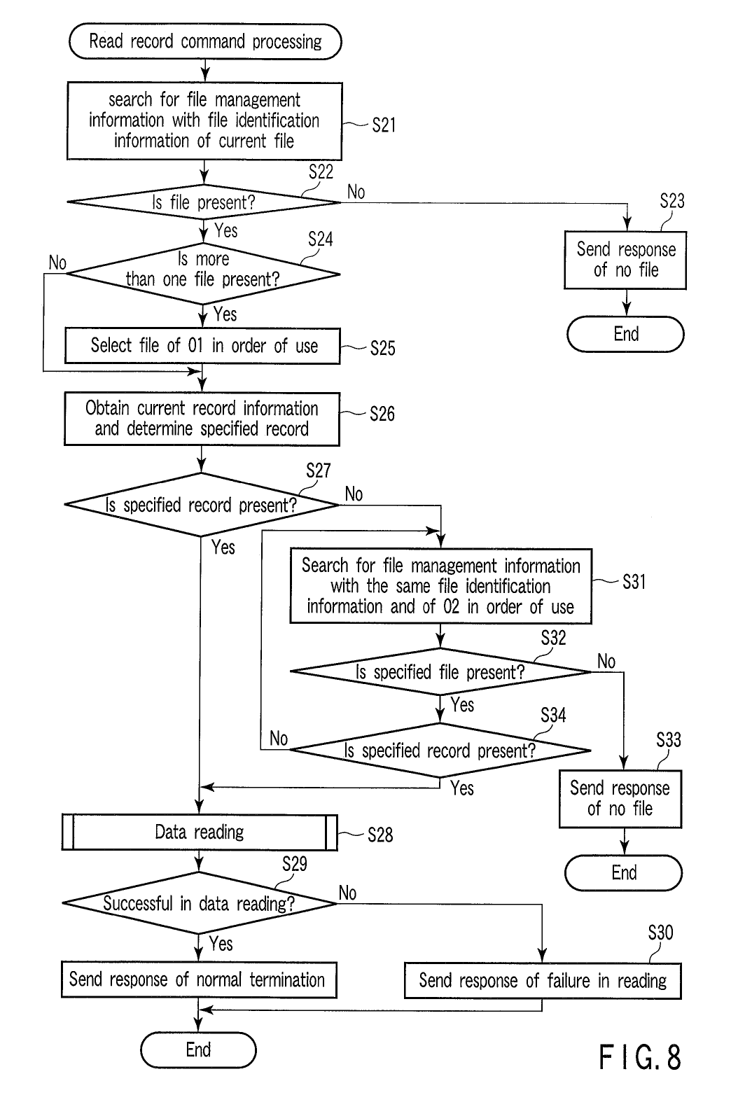

FIG. 8 is a flowchart illustrating the flow of processing associated with the READ RECORD Command (C1).

With the READ RECORD Command (C1), the method for specifying to a data file of record structure a record to be read from is divided into the method to specify the record number and the method to specify the record preceding the current record or the next record. It is assumed that information indicating the current record is held in a memory, such as RAM 103, and is updated as needed with access to each record.

In the description which follows, it is assumed that a file (current file) to be accessed with the READ RECORD Command (C1) is an elementary file having the file identification information of 01 and the linear structure with records of variable length as shown in FIG. 6. It is further assumed that the READ RECORD Command is a command which makes a request to read the next record with reference to the current file. Processing for a READ command to make a request to collectively read records from a specified record to the last record or from the current record to the last record in the file which is first in the order of use can be implemented by repeating such processing as shown in FIG. 8 as processing for reading from each record.

The IC card 1 is activated when powered from the IC card reader/writer 2 to become capable of receiving commands from the card reader/writer. Upon receiving a command from the IC card reader/writer 2, the CPU 101 of the IC card 1 carries out a process of determining the type of the received command. It is assumed here that the received command is the READ RECORD Command. When the command received from the IC card reader/writer 2 is the READ RECORD Command, the CPU 101 carries out such processing as shown in FIG. 8.

That is, upon receiving the READ RECORD Command, the CPU 101 retrieves file management information having file identification information for a file which is currently being selected (current file) from two or more items of file management information stored in the data memory 102 (step S21). If the result of this retrieval process is that there is no file management information having file identification information for the current file (NO in step S22), then the CPU 101 sends a response indicating an error of no file to the IC card reader/writer 2 as the result of processing for the READ RECORD Command and makes the processing cause error termination (step S23).

If the result of the retrieval process is that there is file management information having file identification information for the current file (YES in step S22), then the CPU 101 makes a decision of whether or not there are two or more items of file management information having the same file identification information as that of the current file (step S24).

If the decision is that there are two or more items of file management information having the same file identification information as that of the current file, then the CPU 101 selects as a candidate for access the file having file management information in which the use order information indicates the first in the order of use (step S25). If, on the other hand, there is only one item of file management information having the file identification information of the current file (NO in step S24), then the CPU 101 selects as a candidate for access the file corresponding to that file management information.

For example, if, when there are two or more items of file management information having file identification information of 01 as shown in FIG. 6, the file identification information of the current file is 01, then the CPU 101 selects as a candidate for access the file in which the file identification information is 01 and the use order information is 01 as the results of processing in steps S21 to S25.

When there is a single item of file management information having the file identification information of the current file, it is only one file which can be selected as a candidate for access by the READ RECORD Command. In such a case, the corresponding file is merely processed with the order of use as 01 in the processing shown in FIG. 8.

When a file to be accessed is selected, the CPU 101 fetches information indicating the current record from the RAM 103. Based on the current record indicating information fetched from the RAM 103, the CPU 101 determines the record number of a record specified by the READ RECORD Command (step S26). That is, when the REAS RECORD Command specifies the record next to the current record, the CPU 101 identifies the next record on the basis of the current record indicating information obtained from the RAM 103.

For example, the current record may be indicated by a combination of a record number in a file and the order of use of that file or by assigning a serial number to each record in a file. However, this embodiment supposes to operate commands within constraints defined by prescribed standards (i.e., to use existing commands without changing their specifications). For this reason, it is impossible to directly specify a record in a file which is the third or more in the order of use. However, since the current record indicating information is held within the IC card, it is also possible to hold a record in a file which is the third or more in the order of use as the current record. For example, it is possible to define the record number of each record in a file which is the n-th in the order of use as “1+(maximum number of records in each file)×(n−1)” to “maximum number of records+(maximum number of records in each file)×(n−1)”. In this case, the record number of the record next to the current record will be determined to be the current record number+1.

Upon determining the record number specified by the READ RECORD Command (the record number next to the current record number), the CPU 101 makes a decision of whether or not the record of the specified record number is present in the currently selected file (for example, the file in which the file identification number is 01 and the use order information is 01) (step S27).

For example, when the record numbers of records in the file which is the n-th in the order of use are defined as “1+254×(n−1)” to “254+254×(n−1)”the CPU 101 can decide whether or not the specified record is present in the file which is first in the order of use depending on whether or not the record number is more than 254.

In the description which follows, the CPU 101 makes a decision of whether or not the specified record number is present in the file which is first in the order of use.

If the decision is that the specified record is present in the selected file (YES in step S27), the CPU 101 carries out a process of reading data from the record having the record number specified by the received READ RECORD Command (step S28). If data have been successfully read (YES in step S29), the CPU 101 sends the read data and information indicating normal termination as a response to the IC card reader/writer 2 and terminates the processing for the READ RECORD Command.

If, on the other hand, the data reading process has failed (NO in step S29), the CPU 101 sends a response indicating failure in data reading to the IC card reader/writer 2 and causes the processing for the READ RECORD Command to result in error termination (step S30).

If the decision is that the specified record is not present in the selected file (NO in step S27), then the CPU 101 searches for file management information for a file which has the same file identification information as the current file and is next in the order of use (step S31).

For example, if, when there are two or more items of file management information in which the file identification information is 01 as shown in FIG. 6, the selected file has file identification information of 01 and is first in the order of use, then the CPU selects as a candidate for access a file which has file identification information of 01 and is second in the order of use in step S31.

If the decision is that no next file in the order of use is present (NO in step S32), then the CPU 101 sends a response indicating an error of no specified record to the IC card reader/writer 2 and makes the processing cause error termination (step S33). The process in step S33 is one to send a response indicating that the selected file is present but the specified record is not present in the selected file.

If a file which is next in the order of use has been found (YES in step S32), then the CPU 101 selects that file as a candidate for access and then makes a decision of whether or not the specified record is present in the selected file as in step S27 (step S34).

If the decision is that the specified record is present in the selected file (YES in step S34), then the CPU 101 goes to step S28 to perform a process of reading data from the specified record. If the data have been successfully read (YES in step S29), then the CPU 101 sends the read data and information indicating normal termination as a response to the IC card reader/writer 2 and terminates the processing. If, on the other hand, data reading has resulted in failure (NO in step S29), then the CPU 101 sends a response indicating failure in data reading to the IC card reader/writer 2 and causes the processing for the READ RECORD Command to result in error termination (step S30).

If the decision is that the specified record is not present in the selected file (NO in step S34), then the CPU 101 returns to step S31 to repeat the above processing. This allows the CPU 101 to retrieve the specified record from files having the same file identification information as the current file according to their order of use.

As described above, the IC card of this embodiment retrieves from items of file management information having the same file identification information as that of the current file that file management information which has the use order information indicating the first in the order of use upon receiving the READ RECORD Command. Upon detecting such file management information, the IC card makes a decision of whether or not a record to be read from is present in the file defined by that file management information. If the decision is that no record to be read is present in the file which is first in the order of use, then the IC card searches again for file management information having use order information indicating the second in the order of use. Upon detecting such file management information, the IC card makes a decision of whether or not a record to be read is present in a file defined by that file management information. If the decision is that such a record is present in the file which is second in the order of use, then the IC card reads the record from that file.

That is, the IC card is allowed, upon receiving the READ RECORD Command, to read record data from a file which is second or more in the order of use by deciding whether or not a record to be read is present in files in their order of use. Such processing allows the IC card to read a desired record even if the number of records accessible by one item of file identification information exceeds a maximum number of records that can be stored in one file.

With the READ RECORD Command, it is possible to specify a record to be read with reference to the current record. For example, with the READ RECORD Command, it is possible to specify a record to be read as the record next to the current record. The information indicating the current record is held in the IC card. For this reason, it is also possible to set a file which is second or more in the order of use as the current record. That is, even with an external device which recognizes two or more files having the same file identification information as one file, it is possible to make a request to read record data in a file which is second or more in the order of use by specifying a record to be read with reference to the current record without changing specifications of the READ RECORD Command defined by prescribed standards.

As described above, the embodiment allows more records than 254, the standardized maximum number, to be managed with a single item of file identification information without changing the specifications of the APPEND RECORD Command or the READ RECORD Command defined by prescribed standards, such as ISO/IEC7816-4.

It should be noted that the above-mentioned embodiment is not intended to limit the number of files which have the same file identification information and for which the order of use is set, the maximum number of records in each file, and the type of file. That is, the number of files which are placed in the order of use by file management information can be set arbitrarily. As an example, when ten files are placed in the order of use, values of 1 to 10 are set in order as use order information in their file definition information. The maximum number of records can be set to an arbitrary number other than 254. The embodiment can be applied to any files as long as they are the record structure. That is, the embodiment can also be applied to files of other structures than the linear structure of records of variable length.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic device comprising:
a first memory to store data by file;
a second memory to store a plurality of items of file management information having the same file identification information for files and different file use order information indicating the order of use of the files;
a first access decision section which, upon receiving a command from an external device, makes a decision of whether or not to make access to a first file defined by that file management information, of the plurality of items of file management information having the same file identification information, which has file use order information indicating that the first file is first in the order of use;
a second access decision section which, if the decision by the first decision section is that the first file is not to be accessed, makes a decision of whether or not to make access to a second file defined by that file management information, of the items of file management information having the same file identification information, which has use order information indicating the second file is second in the order of use; and
a processing section which carries out processing corresponding to the command on the file decided by the first or second decision section to be accessed.

2. The portable electronic device according to claim 1, wherein the command is a write command to make a request to write data into a file, the first access decision section makes a decision of whether or not the first file is to be accessed depending on the presence or absence of a free area allowing data to be written into in the first file, and the second access decision section makes a decision of whether or not the second file is to be accessed depending on the presence or absence of a free area allowing data to be written into in the second file.

3. The portable electronic device according to claim 1, wherein the file to be accessed is a file of record structure, the first access decision section makes a decision of whether or not the first file is to be accessed depending on the presence or absence of a free record to store data in the first file, and the second access decision section makes a decision of whether or not the second file is to be accessed depending on the presence or absence of a free record to store data in the second file.

4. The portable electronic device according to claim 1, wherein the command is a read command to make a request to read data from a file, the first access decision section makes a decision of whether or not the first file is to be accessed depending on the presence or absence of a storage area for data to be read in the first file, and the second access decision section makes a decision of whether or not the second file is to be accessed depending on the presence or absence of a storage area for data to be read in the second file.

5. The portable electronic device according to claim 1, wherein the file to be accessed is a file of record structure, the first access decision section makes a decision of whether or not the first file is to be accessed depending on the presence or absence of a record stored with data to be read in the first file, and the second access decision section makes a decision of whether or not the second file is to be accessed depending on the presence or absence of a record stored with data to be read in the second file.

6. The portable electronic device according to claim 5, further comprising a third memory to store information indicating a current record, and wherein the command is a read command by which a record to be read from is specified with reference to the current record, the first access decision section identifies a record specified by the read command with reference to the current record and makes a decision of whether or not to make access to the first file depending on the presence or absence of the specified record in the first file, and the second access decision section identifies a record specified by the read command with reference to the current record and makes a decision of whether or not to make access to the second file depending on the presence or absence of the specified record in the second file.

7. A file management method for use with a portable electronic device comprising:
storing data in a first memory on a file basis;
storing in a second memory a plurality of items of file management information having the same file identification information for files and different file use order information indicating the order of use of the files;
upon receiving a command from an external device, making a first decision of whether or not to make access to a first file defined by that file management information, of the plurality of items of file management information having the same file identification information, which has file use order information indicating that the first file is first in the order of use;
if the decision is that the first file is not to be accessed, making a second decision of whether or not to make access to a second file defined by that file management information, of the items of file management information having the same file identification information, which has use order information indicating the second file is second in the order of use; and
carrying out processing corresponding to the command on the file decided by the first or second decision to be accessed.

8. The method according to claim 7, wherein the command is a write command to make a request to write data into a file, the first decision is made depending on the presence or absence of a free area allowing data to be written into in the first file, and the second decision is made depending on the presence or absence of a free area allowing data to be written into in the second file.

9. The method according to claim 1, wherein the file to be access is a file of record structure, the first decision is made depending on the presence or absence of a free record to store data in the first file, and the second decision is made depending on the presence or absence of a free record to store data in the second file.

10. The method according to claim 7, wherein the command is a read command to make a request to read data from a file, the first decision is made depending on the presence or absence of a storage area for data to be read in the first file, and the second decision is made depending on the presence or absence of a storage area for data to be read in the second file.

11. The method according to claim 7, wherein the file to be accessed is a file of record structure, the first decision is made depending on the presence or absence of a record stored with data to be read in the first file, and the second decision is made depending on the presence or absence of a record stored with data to be read in the second file.

12. The method according to claim 11, further comprising storing information indicating a current record in a third memory, and wherein the command is a read command by which a record to be read from is specified with reference to the current record, the first decision involves identifying a record specified by the read command with reference to the current record and making a decision of whether or not to make access to the first file depending on the presence or absence of the specified record in the first file, and the second decision involves identifying a record specified by the read command with reference to the current record and making a decision of whether or not to make access to the second file depending on the presence or absence of the specified record in the second file.

13. An IC card comprising:
a module; and
a body in which the module is embedded,
the module comprising a first memory to store data by file, a second memory to store a plurality of items of file management information having the same file identification information for files and different file use order information indicating the order of use of the files, a first access decision section which, upon receiving a command from an external device, makes a decision of whether or not to make access to a first file defined by that file management information, of the plurality of items of file management information having the same file identification information, which has file use order information indicating that the first file is first in the order of use, a second access decision section which, if the decision by the first decision section is that the first file is not to be accessed, makes a decision of whether or not to make access to a second file defined by that file management information, of the items of file management information having the same file identification information, which has use order information indicating the second file is second in the order of use, and a processing section which carries out processing corresponding to the command on the file decided by the first or second decision section to be accessed.
